(19) United States
(12) Patent Application Publication
(10) Pub. No.: US 2006/0206444 A1
(43) Pub. Date: Sep. 14, 2006

(54) Services using beliefs and rules for improved flexibility

(75) Inventors: Akram Bou-Ghannam, Lake Worth, FL (US); Victor S. Moore, Lake City, FL (US); Neil Alan Katz, Parkland, FL (US); Thomas Edward Creamer, Boca Raton, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/078,775

(22) Filed: Mar. 11, 2005

(51) Int. Cl. G06N 5/00; G06F 17/00

(52) U.S. Cl. 706/45

(57) ABSTRACT

A method of modifying services can include reading a plurality of beliefs and a plurality of rules. The beliefs can describe at least one of data and a function available from a plurality of service providers. The rules can define conditions for combining different ones of the plurality of beliefs. The method further can include automatically combining at least two beliefs from the plurality of beliefs according to the rules to create a service.

### BACKGROUND

1. Field of the Invention

The present invention relates to Web services and, more particularly, to developing flexible Web services and modifying the behavior of such services.

2. Description of the Related Art

Web services, sometimes called application services, refer to programs operating on a Web server, or other network-connected computer system, which perform some function or task. The provider of a Web service typically is referred to as a Web service provider or application service provider as the case may be. Web services can range in capability from basic services that retrieve a stock quote or check bids for an online auction to more complex services that provide storage management and customer relationship management.

Recent trends have shown an acceleration in the creation and availability of Web services. Notwithstanding the success of Web services in general, the development of these services remains largely a manual, developer driven process. Developers code Web services using conventional software development tools. Accordingly, any redevelopment of existing Web services also is largely manual in nature. In consequence, the development and/or redevelopment of a Web service can be a time consuming and error prone process.

It would be beneficial to provide a way in which Web services can be created in a more automated fashion which overcomes the disadvantages described above.

### SUMMARY OF THE INVENTION

The present invention provides a solution for automatically creating Web services. One embodiment of the present invention can include a method of creating a service. The method can include reading a plurality of beliefs. The beliefs can describe data and/or functions available from a plurality of service providers. A plurality of rules can be read. The rules can define conditions for combining different ones of the plurality of beliefs. The method further can include automatically combining at least two beliefs from the plurality of beliefs according to the rules to create a service.

Another embodiment of the present invention can include a system for creating a service. The system can include a plurality of beliefs describing data and/or functions available from a plurality of service providers. A plurality of rules can be included that defines conditions for combining different ones of the plurality of beliefs. The system further can include a rules engine configured to automatically combine at least two beliefs from the plurality of beliefs according to the plurality of rules to create a service.

Another embodiment of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a schematic diagram illustrating a system for creating Web services in accordance with one embodiment of the present invention.

FIG. 2 is a schematic diagram depicting a simplified illustration of the system of FIG. 1.

FIG. 3 is a flow chart illustrating a method of creating Web services in accordance with the inventive arrangements disclosed herein.

### DETAILED DESCRIPTION OF THE INVENTION

The present invention provides a solution for developing flexible Web services (hereafter “services”). In accordance with the inventive arrangements disclosed herein, the behavior of services can be dynamically modified in real-time without having to develop a new service from the ground up or redesigning an existing service. In accordance with the present invention, a services infrastructure is provided which allows users to access a beliefs data store and a rules data store. Users can add to, delete from, or modify the content of either data store thereby causing one or more services to be created automatically.

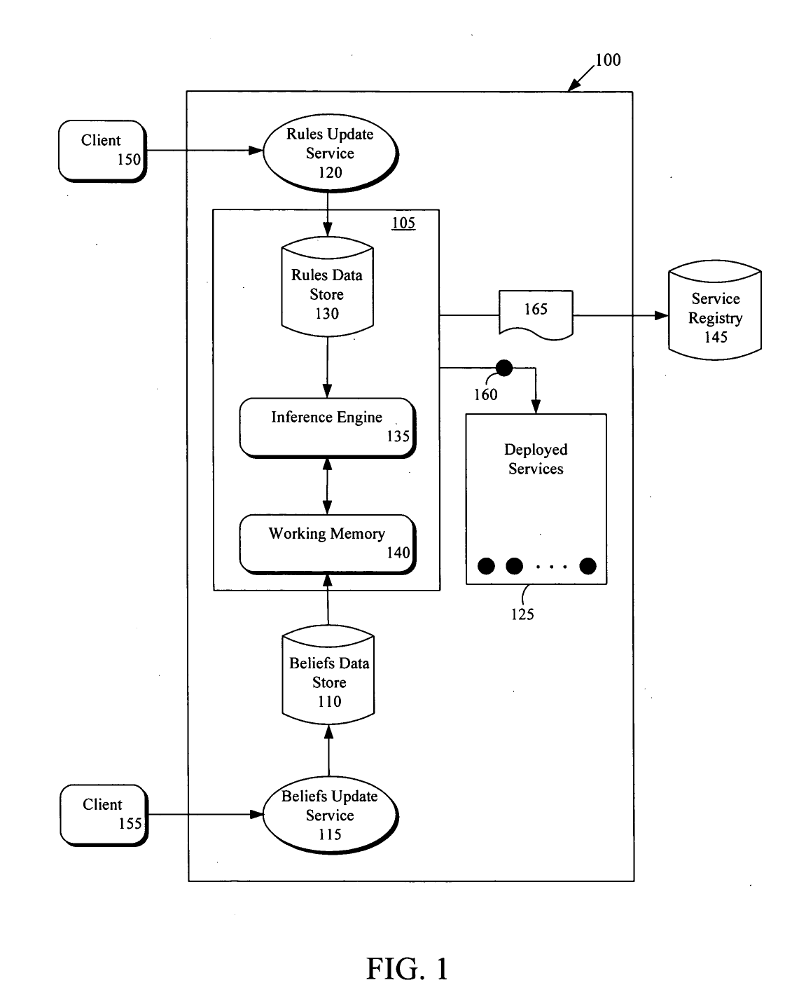

FIG. 1 is a schematic diagram illustrating a system 100 for creating services in accordance with one embodiment of the present invention. System 100 is a belief-based system which relies upon a plurality of beliefs and a plurality of rules to dynamically create services. As shown, system 100 can include a rules engine 105, a beliefs data store 110, a beliefs update service 115, and a rules update service 120. Also included can be a repository 125 of deployed services.

The rules engine 105, which will be described herein in greater detail, can analyze beliefs and rules to automatically generate services thereby altering the functionality or behavior of system 100. As used herein, beliefs can refer to simple, parsable statements that define truths about data and/or functions available from a service provider. Examples of beliefs that can be incorporated into system 100 can include, but are not limited to, “I have a database”, “the database includes hotel information”, and “the hotel information includes price information”. In this example, each of the three beliefs describes the data available from a particular service provider. The beliefs exhibit increasing specificity in describing that data.

As noted, however, beliefs also can be associated with services or functions for manipulating the data available from a service provider. In illustration, a belief stating that “the hotel information includes price information” can be associated with a function, available from a service provider. That function can retrieve the pricing information from the database of hotel information as maintained by that service provider. Accordingly, if a belief states that a service provider offers a particular type of data, that belief can be associated with a service available from that service provider, or another, for obtaining that data.

In another example, a belief can state that “I have a reservation tool” indicating that the service provider maintains a program or other service allowing users to make reservations. As known, the interface to such functions or services can be published, registered with, or otherwise made available to system 100 such that the service described by the belief is available. Such a service can be associated with, or identified by, the belief stating that a reservation tool exists.

Thus, the beliefs data store 110 can include a plurality of beliefs, each stating a single truth about information or a function available from a service provider. While the beliefs can be hierarchically ordered in that each can provide increasingly specific information pertaining to a particular data collection or function, the beliefs need not be interrelated. In other words, the beliefs data store 110 can include a variety of different beliefs, each corresponding to a different service provider. Each belief corresponding to a particular service provider need not be related to other beliefs associated with that same service provider.

The rules engine 105 can include a rules data store 130, an inference engine 135, and a working memory 140. The rules data store 130 can include a plurality of rules which describe the conditions under which new services are to be created. For example, possible rules can include, but are not limited to, “if I have a database and if the database contains hotel information and if the hotel information includes price, then return price”. Such a rule, when interpreted by the inference engine 135, would cause a service for returning prices from hotel information to be created.

The inference engine 135 can load one or more beliefs and rules from the beliefs data store 110 and the rules data store 130 into working memory 140. Within the working memory 140, the inference engine 135 can process the beliefs and rules to dynamically create services accordingly. In one embodiment, the rules engine 105 can be implemented as an expert system where the rules data store 110 (or Knowledge Base) is applied, or matched, to the set of facts, in this case beliefs, in order to determine which rules will be executed or “fire”.

According to another embodiment of the present invention, the rules data store 130 can exist outside of the rules engine 105. In such an embodiment, the rules engine 105 can include the inference engine 135 and the working memory 140. The rules data store 130, while not included within the rules engine, still can be included as part of the system 100.

Services that have been created can be stored by the rules engine 105 within the repository 125 of deployed services. The rules engine 105 further can publish descriptions of newly created or modified Web services to the service registry 145. In one embodiment of the present invention, the service registry can be implemented as a Universal Description, Discovery, and Integration (UDDI) business registry. UDDI allows service providers to list themselves and publish the Web services that each service provider makes available over the Internet or Web.

The belief-based system 100 permits users to access both the beliefs and rules through appropriate interfaces. The rules update service 120 allows users to access the rules data store 130. Rules update service 120 can facilitate the addition of new rules to the rules data store 130 and deletion or modification of existing rules within the rules data store 130. Similarly, the beliefs update service 115 allows users to access the beliefs data store 110. Through the beliefs update service 115, users can add beliefs to the beliefs data store 110 and delete or modify existing beliefs.

In operation, a user working through client 150 can access the rules update service 120 to add, modify, or delete rules as may be required. Similarly, a user working with client 155 can access the beliefs update service 115 to add, modify, or delete beliefs. It should be appreciated that while a single client is shown accessing each of the respective update services, more than one client can access the update services. As such, the present invention is not so limited.

The rules engine 105 can process beliefs and rules stored in system 100. Based upon the data within the rules data store 130 and the beliefs data store 110, the inference engine 135 can create one or more new services. Once created, a new service, for example service 160, can be stored in repository 125. A description 165 of the service can be made available to the service registry 145.

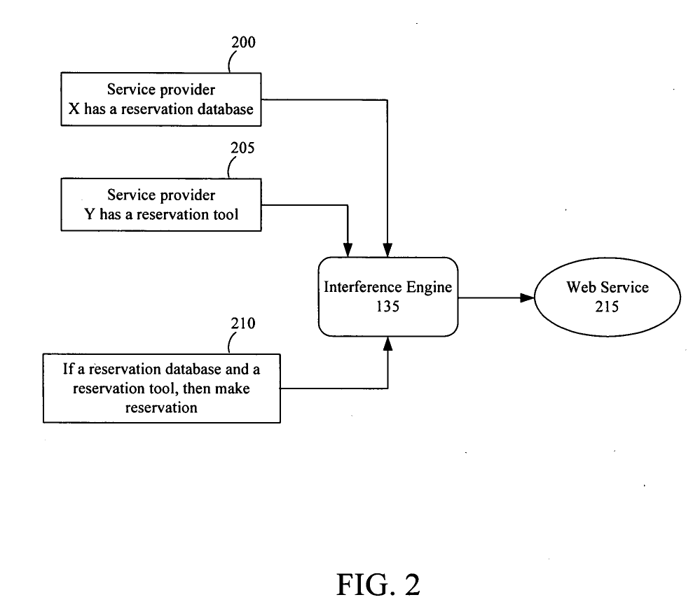

FIG. 2 is a schematic diagram depicting a simplified illustration of the system of FIG. 1. FIG. 2 illustrates one aspect of the interplay between beliefs and rules. For purposes of illustration, the system is shown to have two beliefs 200 and 205. Belief 200 indicates that service provider X has a reservation database. Belief 205 indicates that service provider Y has a reservation tool or system.

In accordance with the inventive arrangements disclosed herein, each service provider can access the beliefs data store to add, delete, or modify beliefs. Thus, in this case, service provider X has added belief 200 to the beliefs data store. Belief 200 provides a description of the type of information maintained by service provider X. Similarly, service provider Y has added belief 205 to the beliefs data store. Belief 205 provides a description of a function that is available from service provider Y.

In this case, service providers X and Y each have incomplete systems. That is, service provider X has a reservation database but no means of making a reservation. Service provider Y has a means for making a reservation, but no reservation database with which the reservation tool is to work. Taken separately, neither service provider X nor service provider Y can provide a complete reservation service.

Rule 210, however, indicates that if a reservation database and a reservation tool exist, then make a reservation. Rule 210, when interpreted by the inference engine 135, will cause a new service 215 to be created. Service 215 will combine the reservation database of service provider X with the reservation tool of service provider Y to create service 215 for making reservations. Rule 210 does not state any preference as to whether each belief to be combined to create service 215 is from the same service provider.

The inference engine 135 reads the beliefs and rules. When conditions specified by a rule are met, the inference engine 135 can execute the rule causing a new service to be created. As used herein, the creation of a new service also can include the case where an existing service is updated. For example, if beliefs and rules exist within the system which have already been used to define a service, those beliefs and/or rules, can be modified or updated. The inference engine 135 can process the modified beliefs and/or rules to create a new service. The new service can be an updated version of the prior service. The updated service can co-exist within the repository with the prior version of the service or can overwrite the prior version of the service.

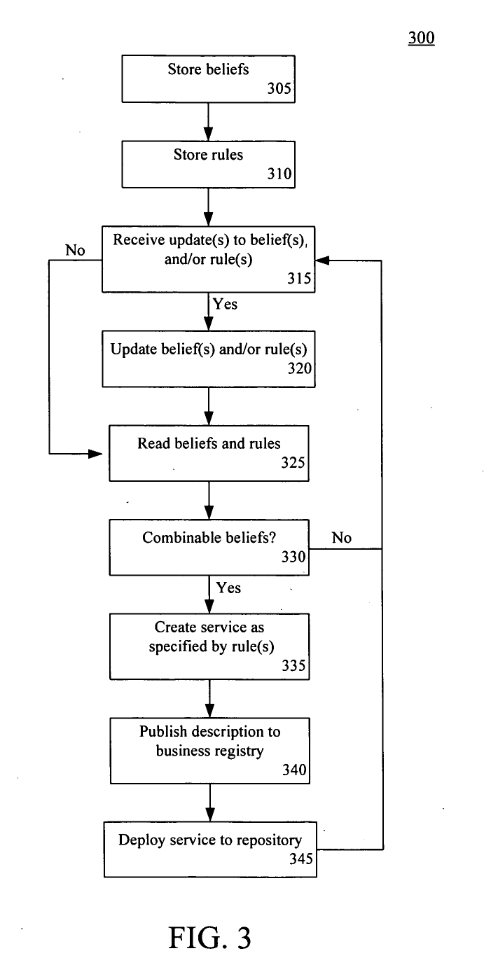

FIG. 3 is a flow chart illustrating a method 300 of creating services in accordance with the inventive arrangements disclosed herein. The method 300 can be implemented by the system illustrated with reference to FIGS. 1 and 2. In any case, the method 300 can begin in step 305, where beliefs are stored within a beliefs data store. The beliefs can be defined or programmed by one or more different service providers. As noted, the beliefs can specify basic truths about the information and/or services provided by each service provider.

For example, the following beliefs can be programmed in the system by a particular service provider: “I have a database”, “the database includes hotel information”, and “the hotel information includes price information”. Additional beliefs such as “I have a database”, “the database includes hotel information”, and “the hotel information includes reservations” can be programmed by a different service provider.

In step 310, rules can be stored in a rules data store. The rules, as was the case with the beliefs, can be specified by one or more different service providers. An example of a rule that can be programmed by a service provider can be “if I have a database and if the database contains hotel information, and if the hotel information includes price, then return price”. Another example can be “if I have a database and if the database includes hotel information, then return the hotel information”. Such rules can be programmed by a service provider, whether the service provider is using only beliefs associated with itself, or beliefs associated with a plurality of different service providers. Moreover, the present invention allows other service providers to observe the beliefs and/or rules existing within the system and use those components as building blocks to create new rules and services.

In step 315, a determination can be made as to whether one or more update(s) to belief(s) and/or rule(s) have been received. If so, the method can proceed to step 320 where the belief(s) and/or rule(s) can be modified as specified by the received update. The method then can proceed to step 325. Receiving updates to the beliefs and/or rules allows service providers to dynamically change the behavior of the system through the creation of a new service. If no update is received in step 315, the method can proceed directly to step 325.

In step 325, the beliefs and rules can be read by the inference engine. In. one embodiment, the rules engine can detect additions, deletions, and changes with respect to rules and beliefs. Such changes can trigger the rules engine to automatically process beliefs and rules to create services. In another embodiment, such processing can be scheduled on a periodic basis or triggered from time to time. In step 330, the inference engine can determine whether any beliefs are combinable, based upon the rules, to create new services. If so, the method can proceed to step 335. If not, the method can loop back to step 315 to continue monitoring for further updates to the beliefs and/or rules.

Continuing with step 335, one or more services can be created in accordance with the rules. Taking the rule “if I have a database and if it contains hotel information, then return the hotel information” as an example, the inference engine can create a service that will return price and reservation information. That is, the inference engine, upon reviewing the beliefs and this rule, determines that hotel information does exist and that the hotel information includes both price and reservation information. Notably, the price information can be provided by one service provider, while the reservation information can be provided by another service provider. The newly created service can access both service providers to obtain more complete hotel information including price and reservation data.

Though the beliefs necessary to form the Web service specified by the rule correspond to two different service providers, the beliefs can be combined nonetheless. It should be appreciated that while two service providers are used within this example, services can be created from beliefs corresponding to one or more service providers. The particular number of service providers that provide the beliefs to be combined into a service is not intended to be a limitation of the present invention.

In step 340, a description of the newly created service can be published to an online, or network accessible, business registry. In step 345, the service can be deployed to the repository of services within the belief-based system. After step 345, the method can loop back to step 315 to continue processing as may be required.

The method described herein has been provided for purposes of illustration and, as such, is not to be construed as a limitation of the present invention. For example, one or more of the steps described with reference to FIG. 3 can be performed in a different order than described herein.

The inventive arrangements disclosed herein provide a method, system, and apparatus that facilitates dynamic, real-time creation of Web services. Through the present invention, users can specify beliefs and/or rules. Using these components, the rules engine can automatically create Web services. The present invention allows the behavior of an existing system to be modified without having to redesign the system.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, or other variations of these terms, in the present context, means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of creating services comprising:
reading a plurality of beliefs, wherein the beliefs describe at least one of data and a function available from a plurality of service providers;
reading a plurality of rules defining conditions for combining different ones of the plurality of beliefs; and
automatically combining at least two beliefs from the plurality of beliefs according to the rules to create a service.

2. The method of claim 1, further comprising publishing the service to a network-accessible business registry.

3. The method of claim 1, wherein the at least two beliefs that are automatically combined correspond to at least two different service providers.

4. The method of claim 1, further comprising, responsive to receiving an input, modifying one of the plurality of beliefs.

5. The method of claim 4, further comprising automatically combining the modified belief and at least one other of the plurality of beliefs according to the rules to form a second service.

6. The method of claim 1, further comprising, responsive to receiving an input, modifying one of the plurality of rules.

7. The method of claim 6, further comprising automatically combining at least two different beliefs from the plurality of beliefs according to the modified rule to form a second service.

8. A system for creating services comprising:
a plurality of beliefs describing at least one of data and functions available from a plurality of service providers;
a plurality of rules defining conditions for combining different ones of the plurality of beliefs; and
a rules engine configured to automatically combine at least two beliefs from the plurality of beliefs according to the plurality of rules to create a service.

9. The system of claim 8, wherein the rules engine is configured to automatically deploy the service.

10. The system of claim 8, wherein the rules engine is configured to automatically publish the service to a network-accessible business registry.

11. The system of claim 8, further comprising a service configured to provide an interface through which beliefs can be modified.

12. The system of claim 8, further comprising a service configured to provide an interface through which rules can be modified.

13. The system of claim 8, wherein the at least two beliefs that are automatically combined correspond to at least two different service providers.

14. A machine readable storage, having stored thereon a computer program having a plurality of code sections executable by a machine for causing the machine to perform the steps of:
reading a plurality of beliefs, wherein the beliefs describe at least one of data and a function available from a plurality of service providers;
reading a plurality of rules defining conditions for combining different ones of the plurality of beliefs; and
automatically combining at least two beliefs from the plurality of beliefs according to the rules to create a service.

15. The machine readable storage of claim 14, further comprising publishing the service to a network-accessible business registry.

16. The machine readable storage of claim 14, wherein the at least two services that are automatically combined correspond to at least two different service providers.

17. The machine readable storage of claim 14, further comprising, responsive to receiving an input, modifying one of the plurality of beliefs.

18. The machine readable storage of claim 17, further comprising automatically combining the modified belief and at least one other of the plurality of beliefs according to the rules to form a second service.

19. The machine readable storage of claim 14, further comprising, responsive to receiving an input, modifying one of the plurality of rules.

20. The machine readable storage of claim 19, further comprising automatically combining at least two different beliefs from the plurality of beliefs according to the modified rule to form a second service.
